(19) United States
(12) Patent Application Publication
(10) Pub. No.: US 2012/0200856 A1
(43) Pub. Date: Aug. 9, 2012

(54) SAMPLE ANALYSIS APPARATUS

(75) Inventor: Su Bong BAE, Suwon-si (KR)

(73) Assignee: SAMSUNG ELECTRONICS CO., LTD., Suwon-si (KR)

(21) Appl. No.: 13/368,093

(22) Filed: Feb. 7, 2012

(30) Foreign Application Priority Data
Feb. 9, 2011 (KR) 10-2011-0011512

(51) Int. Cl. G01N 21/59; G01N 21/88

(52) U.S. Cl. 356/432

(57) ABSTRACT

A sample analysis apparatus to detect detection objects at various positions is provided. The sample analysis apparatus includes a disc including first and second detective regions. The first detective region is located at a first distance in a radial direction from the center of the disc and the second detective region is located at a second distance greater than the first distance. The apparatus further includes a light emitting element spaced apart from an upper or lower surface of the disc by a predetermined distance so as to face the first and second detective regions, and first and second light receiving elements positioned on the opposite side of the disc as that of the light emitting element while being respectively oriented to face the first and second detective regions. The light emitting element is configured to irradiate a uniform intensity of light onto the detective regions.

### CROSS-REFERENCE TO RELATED APPLICATION

This application claims priority from Korean Patent Application No. 10-2011-0011512, filed on Feb. 9, 2011 in the Korean Intellectual Property Office, the disclosure of which is incorporated herein by reference.

### BACKGROUND

1. Field

Apparatuses and methods consistent with exemplary embodiments relate to a sample analysis apparatus that detects reaction results of detection objects placed at various locations.

2. Description of the Related Art

In general, a microfluidic device includes microfluidic structures in which a fluid is movably accommodated to perform a variety of tests, which including biochemical reactions. An exemplary microfluidic device is a disc containing microfluidic structures, the disc being rotatable about a rotating shaft.

A variety of tests using such discs may be performed by injecting a sample into the disc to cause biochemical reactions, and detecting the reaction results. In order to enable easy detection of the reaction results, the biochemical reactions occurring within the disc may be rendered to exhibit optical variations.

In the related art, reaction results have been detected with an inspector's naked eye. In this case, reaction results rely on subjective judgments of an inspector, having low reliability.

Therefore, detection apparatuses to quantitatively detect reaction results of a detection object have been developed to increase reliability. Such a detection apparatus may include a light emitting device to irradiate light onto a detection object and a camera module to measure transmittance or reflectance of light. Accurate detection of reaction results may require irradiation of a uniform intensity of light throughout the detection object and positioning of the camera module at a location where light transmitted through or reflected from the detection object is detectable by the camera module.

However, it may be difficult to detect reaction results of a detection object using only a single camera module because various sizes of discs may be used and because detection objects may be arranged at different radial distances from the center of the disc even when the discs used have the same size.

### SUMMARY

Exemplary embodiments provide a sample analysis apparatus to detect reaction results of detection objects placed at various locations. Additional embodiments will be set forth in part in the description which follows.

According to an aspect of an exemplary embodiment, there is provided a sample analysis apparatus including a rotatable disc, a first detective region and a second detective region defined in the disc, wherein the first detective region is located at a first distance in a radial direction from the center of the disc and the second detective region is located at a second distance greater than the first distance, a light emitting element spaced apart from any one of an upper surface and a lower surface of the disc by a predetermined distance so as to face the first detective region and the second detective region, the light emitting element serving to irradiate a uniform intensity of light to the first detective region and the second detective region, and a first light receiving element and a second light receiving element arranged opposite to the light emitting element on the basis of the disc and oriented, respectively, to face the first detective region and the second detective region.

A light emitting surface of the light emitting element may cover both the first detective region and the second detective region.

The light emitting element may include a backlight unit to irradiate a uniform intensity of light in a given direction.

The first light receiving element may detect the amount of light transmitted through the first detective region.

The first light receiving element may include a camera module to capture images of the first detective region.

The light emitting element may be placed above the disc, and the first light receiving element may be placed below the disc.

The sample analysis apparatus may further include a controller to control operations of the first light receiving element and the second light receiving element, wherein the controller includes a plurality of control channels and is connected to the first light receiving element and the second light receiving element via the respective control channels.

The sample analysis apparatus may further include a controller to control operations of any one of the first light receiving element and the second light receiving element, and a connector to connect the first light receiving element and the second light receiving element to the controller.

The connector may include a first connector to connect the controller and the first light receiving element to each other and a second connector to connect the controller and the second light receiving element to each other.

In accordance with an aspect of another exemplary embodiment, there is provided a sample analysis apparatus including a rotating device to which any one of a first disc and a second disc is selectively mounted, wherein the first disc has a first radius and is provided with a first detective region and the second disc has a greater radius than the first radius and is provided with a second detective region, a light emitting element spaced apart from the first disc and the second disc to irradiate a uniform intensity of light to the first detective region and the second detective region, and a first light receiving element and a second light receiving element spaced apart respectively from the first detective region and the second detective region to receive light transmitted through the first detective region and the second detective region.

The light emitting element may have a light emitting surface that irradiates a uniform intensity of light in a given direction. The first detective region and the second detective region may be contained in a light emitting region of the light emitting surface.

Each of the first light receiving element and the second light receiving element may include a camera module to detect the amount of light transmitted through the first detective region.

The sample analysis apparatus may further include a controller to control operations of any one of the first light receiving element and the second light receiving element, and a connector to connect the first light receiving element and the second light receiving element to the controller, wherein the connector includes a first connector to connect the controller and the first light receiving element to each other and a second connector to connect the controller and the second light receiving element to each other.

In accordance with an aspect of another exemplary embodiment, there is provided a sample analysis apparatus including a disc having a first detective region and a second detective region radially spaced apart from each other, a light emitting element placed above the disc to irradiate a uniform intensity of light to the first detective region and the second detective region, a first light receiving element and a second light receiving element placed below the disc to receive light transmitted through the first detective region and the second detective region, respectively, a controller to control operations of the first light receiving element and the second light receiving element, and a connector to connect only one of the first light receiving element and the second light receiving element to the controller.

### BRIEF DESCRIPTION OF THE DRAWINGS

The above and/or other aspects will become apparent and more readily appreciated from the following description of exemplary embodiments, taken in conjunction with the accompanying drawings of which:

FIG. 1 is a plan view illustrating various components of a disc according to an embodiment;

FIG. 2 is a side view illustrating various components of a sample analysis apparatus according to an embodiment;

FIGS. 3A and 3B are plan views illustrating main components of a disc according to another embodiment;

FIG. 4 is a side view illustrating various components of a sample analysis apparatus according to another embodiment; and

FIGS. 5A and 5B are views illustrating a controller, to which light receiving elements are connected, in a sample analysis apparatus according to an embodiment.

### DETAILED DESCRIPTION

Reference will now be made in detail to exemplary embodiments, examples of which are illustrated in the accompanying drawings, wherein like reference numerals refer to like elements throughout.

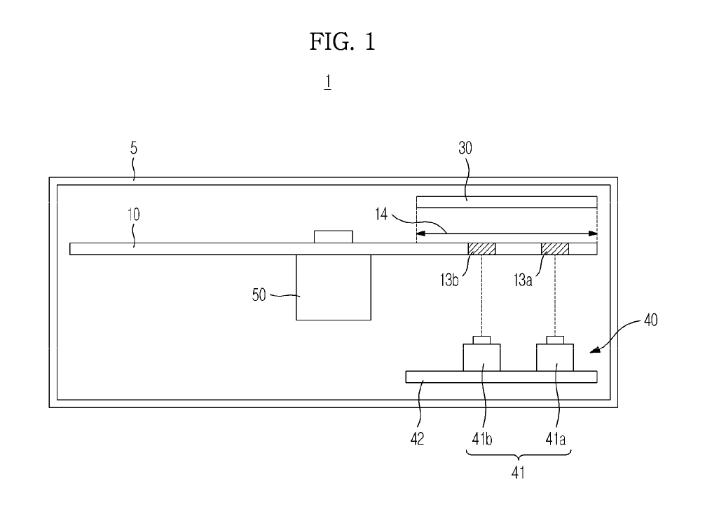

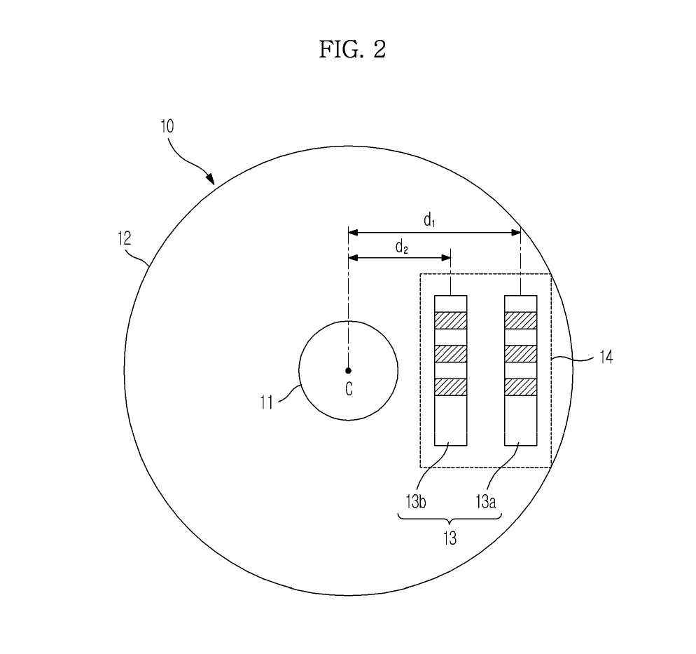

FIG. 1 is a plan view illustrating main components of a disc according to an exemplary embodiment, and FIG. 2 is a side view illustrating main components of a sample analysis apparatus according to an exemplary embodiment.

As illustrated in FIGS. 1 and 2, the sample analysis apparatus 1 includes a disc 10, a rotating device 50 to rotate the disc 10, a light emitting element 30 to irradiate light onto the disc 10, and a light receiving element 40 to receive transmitted light. The sample analysis apparatus 1 may include a case 5 defining an outer appearance of the apparatus.

The disc 10 may include a disc-shaped platform 12, a plurality of chambers defined in the platform 12 to accommodate a fluid therein, and a plurality of channels for fluid flow. The disc 10 has a center hole 11 having a predetermined diameter, into which the rotating device 50 may be fitted to rotate the disc 10. The rotating device 50 may include a spindle motor (not shown) fitted into the center hole 11 to rotate the disc 10.

The platform 12 may be formed of a plastic, such as acryl, polydimethylsiloxane (PDMS), etc., which is easy to mold and has biologically inert superficial properties. However, the platform 12 is not limited thereto and in other embodiments, may be formed of other materials so long as they exhibit biological stability, optical transparency and mechanical workability.

The platform 12 may be constructed by multilayered plates. The platform 12 may contain spaces and passages therein by forming intaglio structures corresponding to chambers, channels, etc. at interfaces of contact plates and bonding the plates to each other. For example, the platform 12 may include an upper plate and a lower plate attached to the upper plate, or may include upper and lower plates with a partition, which defines chambers for fluid accommodation and channels for fluid flow, interposed therebetween. Bonding of the upper and lower plates may be accomplished by various methods, such as attachment using an adhesive or double-sided adhesive tape, ultrasonic fusion, laser welding, etc.

The disc 10 includes a detective region 13 provided to allow results of reactions occurring within the disc 10 to be detected from the outside of the disc 10. The detective region 13 may contain, e.g., a chamber in which a resultant substance of a reaction between a sample and a reagent within the disc 10 is accommodated, and a reagent cartridge disposed therein to react with a sample.

Reaction results may be detected by irradiating a specific wavelength of light onto the detective region 13 and measuring variation in the wavelength of light transmitted through the detective region 13, or by irradiating light to the detective region 13 and capturing an image of the detective region 13. Detection of reaction results is not limited to the above description and in other embodiments, various other methods based on the principle that light irradiated onto the detective region 13 may be transmitted through or reflected from the detective region 13, and may be used for detection.

In one exemplary embodiment, the single disc 10 may be provided with a plurality of detective regions 13a and 13b. The plurality of detective regions may be located at different radial distances from the center C of the disc 10. Thus, the disc 10 may include a first detective region 13a and a second detective region 13b located, respectively, at a first distance d1 and a second distance d2 in a radial direction from the center C of the disc 10.

The light emitting element 30 is spaced apart from an upper surface or a lower surface of the disc 10 by a predetermined distance to irradiate light onto the first detective region 13a and/or the second detective region 13b. Thus, the light emitting element 30 may be disposed over the disc 10 by a predetermined distance to irradiate light downward onto the first detective region 13a and the second detective region 13b.

In another exemplary embodiment, the light emitting element 30 is disposed over the disc 10 to irradiate a uniform intensity of light onto the first detective region 13a and/or the second detective region 13b. A minimum distance between the light emitting element 30 and the first detective region 13a may be equal to a minimum distance between the light emitting element 30 and the second detective region 13b.

The light emitting element 30 may include a backlight unit that is designed to irradiate a uniform intensity of light over a predetermined area. However, the light emitting element 30 may also include various other planar light sources having predetermined cross sectional areas of a light emitting surface, the planar light sources being oriented to face the first detective region 13a and/or the second detective region 13b.

An irradiation region 14 is defined on the surface of the disc 10 facing the light emitting element 30 such that the light emitting element 30 irradiates light onto the irradiation region 14. The first detective region 13a and the second detective region 13b are located within the irradiation region 14 and a uniform intensity of light is irradiated to the irradiation region 14. Alternatively, instead of locating both the first and second detective regions 13a and 13b within the irradiation region 14, any one of the first detective region 13a or the second detective region 13b may be located within the irradiation region 14. This will be described below.

The light receiving element 40 is placed at an opposite side of disc as that of the light emitting element 30 on the basis of the detective region 13, so as to receive light transmitted through the detective region 13. The light receiving element 40 and the detective region 13 may be equal in number. In an exemplary embodiment, the light receiving element 40 includes a first light receiving element 41a and a second light receiving element 41b to correspond to the first detective region 13a and the second detective region 13b, respectively. The first light receiving element 41a may receive light that is irradiated from the light emitting element 30 and transmitted through the first detective region 13a and the second light receiving element 41b may receive light that is irradiated from the light emitting element 30 and transmitted through the second detective region 13b. The first light receiving element 41a and the second light receiving element 41b may be secured to a substrate 42.

The light receiving element 40 may include a camera module to capture images of the detective region 13. The camera module may produce data regarding reaction results revealed from the detective region 13 by capturing images of the detective region 13. The camera module may include image capturing devices, such as Complementary Metal Oxide Semiconductors (CMOSs) or Charge-Coupled Devices (CCDs).

First, a sample is injected into the disc 10. The sample may be a bodily fluid, such as blood, saliva, urine, etc. A certain substance, such as a reagent, etc., is provided in the disc 10 so as to react with a specific ingredient contained in the sample. While the disc 10 is rotated by the rotating device 50, reaction between the sample and the reagent occurs within the disc 10 and results of the reaction are revealed in the detective region 13. To detect the reaction results, the light emitting element 30 irradiates light onto the detective region 13 and the light receiving element 40 receives the light transmitted through the detective region 13.

Data regarding the reaction results using the light received by the light receiving element 40 may be produced in various ways. In one example, the wavelength of light irradiated from the light emitting element 30 may be compared with the wavelength of light that is transmitted through the detective region 13 and received by the light receiving element 40. Comparing the wavelengths of light may indicate whether reaction between a specific ingredient of the sample and the reagent has occurred, with results of the reaction being revealed in the detective region 13. Once reaction results are revealed in the detective region 13, the degree of the reaction may be detected by calculating variation in the wavelength of light.

In an exemplary embodiment of the sample analysis apparatus 1, the light receiving element 40 includes a camera module. Thus, the reaction results revealed in the detective region 13 may contain optical variation, such as, but not limited to, variation in the color or density of substances in the detective region 13. The light receiving element 40 may produce data regarding variation in the color or density of the detective region 13 by capturing images of the detective region 13 and then, may quantitatively analyze the results of the reaction occurring in the disc 10.

In another exemplary embodiment, a plurality of point light sources may be arranged to irradiate light onto the plurality of detective regions located at different distances from the center C of the disc 10. In this case, the plurality of point light sources may take the form of an LED array. However, the plurality of point light sources may have difficulty in irradiating a uniform intensity of light throughout the plurality of detective regions because light irradiated from the plurality of point light sources can overlap each other. Moreover, due to the fact that the plurality of detective regions may have different intervals therebetween even if they are located at the same radial distance from the center C of the disc 10, arranging the point light sources to correspond to the detective regions may necessitate a change in the configuration of the light emitting element 30.

As such, the sample analysis apparatus 1 may employ a planar light source, such as a backlight unit and therefore, may irradiate a uniform intensity of light throughout the plurality of detective regions to efficiently deal with various arrangements of the plurality of detective regions.

Although the light emitting element 30 and the light receiving element 40 provided in the sample analysis apparatus 1 according to an exemplary embodiment are located opposite to each other on the basis of the detective region 13, both the light emitting element 30 and the light receiving element 40 may be arranged on the same side of the detective region 13. In this case, the light receiving element 40 serves to receive light reflected from the detective region 13.

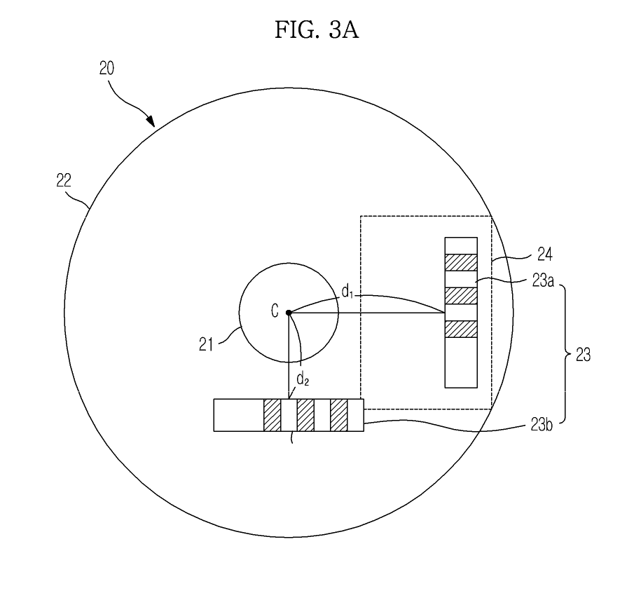

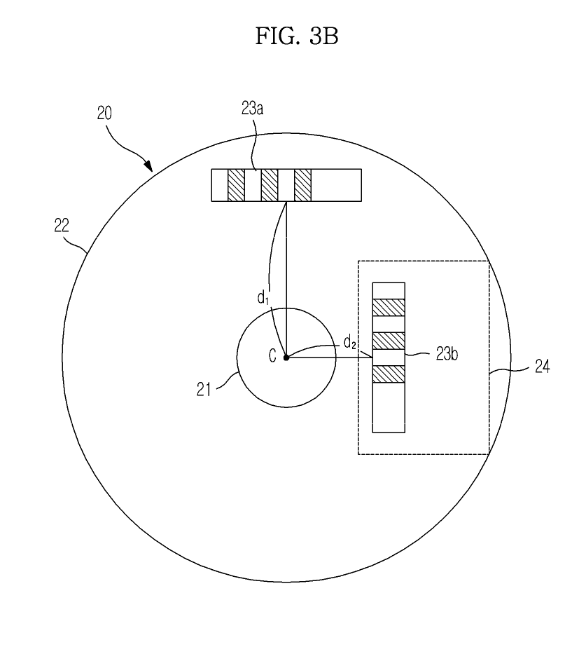

FIGS. 3A and 3B are plan views illustrating various components of a disc according to another exemplary embodiment.

A disc 20 includes a platform 22, a center hole 21 and a detective region 23. Additionally, an irradiation region 24 is defined on the disc 20. Since the platform 22, the center hole 21 and the irradiation region 24 are respectively identical those described in FIG. 2, a description thereof will be omitted hereinafter. The detective region 23 may include a first detective region 23a and a second detective region 23b, which are located at different distances from the center C of the disc 20.

In this embodiment, the first detective region 23a and the second detective region 23b are not located on the same radial line about the center C of the disc 20. Thus, only one of the first detective region 23a and the second detective region 23b may be located in the irradiation region 24.

As illustrated in FIG. 3A, assuming that reaction results are revealed in the first detective region 23a and the second detective region 23b, first, the first detective region 23a is positioned in the irradiation region 24. Then, light is irradiated onto the first detective region 23a so as to enable the detection of reaction results in the first detective region 23a.

After detecting the reaction results of the first detective region 23, the second detective region 23b is positioned within the irradiation region 24 to enable detection of the reaction results in the second detective region 23b, as illustrated in FIG. 3B. In this case, positioning of the second detective region 23b within the irradiation region 24 is accomplished by operating a rotating device (not shown) fitted to the center hole 21 of the disc 20.

Detecting the reaction results by irradiating light onto the first detective region 23a and subsequently onto the second detective region 23b, and receiving transmitted light is identical to the above description in relation to FIGS. 1 and 2.

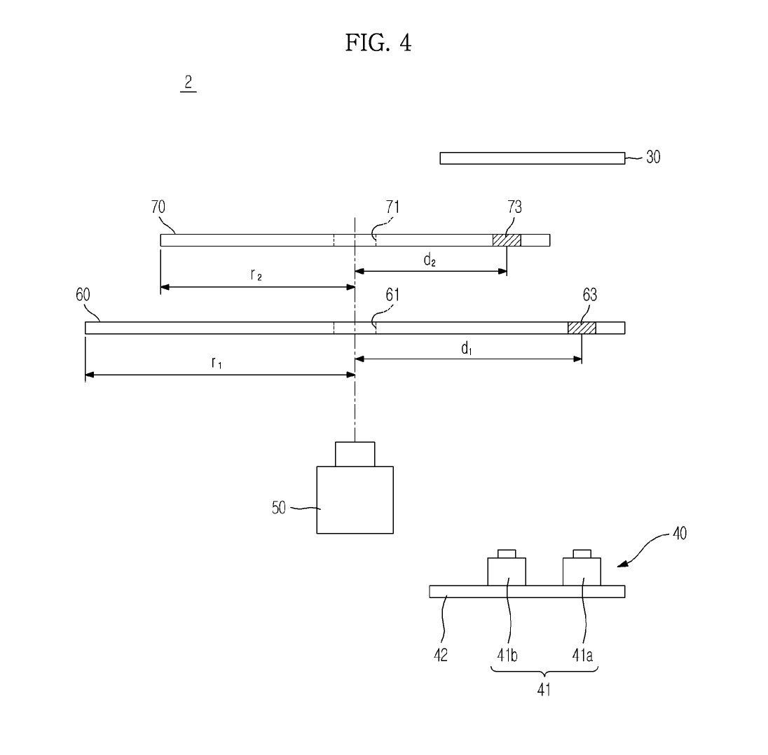

FIG. 4 is a side view illustrating various components of a sample analysis apparatus according to another exemplary embodiment.

As illustrated in FIG. 4, the sample analysis apparatus 2 includes a rotating device 50, a light emitting element 30 to irradiate light and a light receiving element 40 to receive transmitted light. A first disc 60 having a first radius r1 and a second disc 70 having a second radius r2 are selectively mounted to the rotating device 50. While not shown in FIG. 4, the sample analysis apparatus 2 may include a case as shown in FIG. 1, defining an outer appearance of the apparatus.

The first disc 60 includes a first detective region 63 located at a first distance d1 from the center thereof, and the second disc 70 includes a second detective region 73 located at a second distance d2 from the center thereof. The first distance d1 and the second distance d2 are different from each other.

The sample analysis apparatus 2 may include a light emitting element 30 to irradiate a uniform intensity of light to both the first detective region 63 and the second detective region 73, and first and second light receiving elements 41a and 41b to receive light transmitted respectively through the first detective region 63 and the second detective region 73. Thus, the sample analysis apparatus 2 may measure results of reactions occurring in both the first and second discs 60 and 70 having different diameters.

However, in certain embodiments the first disc 60 and the second disc 70 may have the same diameter, and even in this case, the distance between the rotating shaft of the rotating device 50 and the first detective region 63 may be different from the distance between the rotating shaft of the rotating device 50 and the second detective region 73.

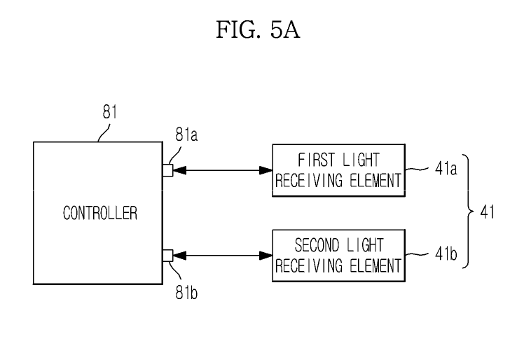

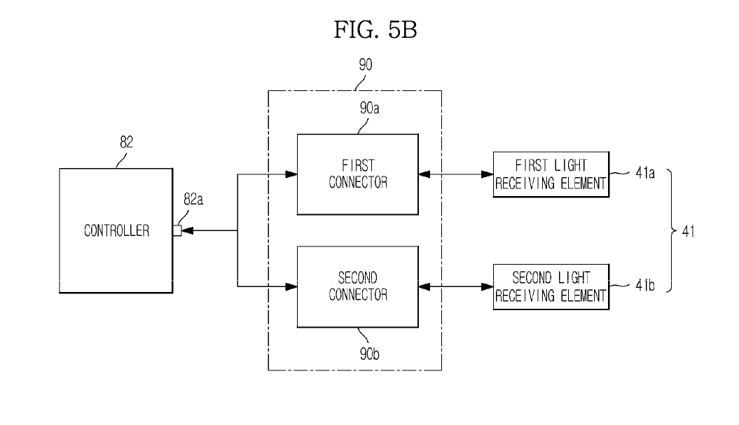

FIGS. 5A and 5B are views illustrating an exemplary controller, to which the light receiving element is connected, in the sample analysis apparatus according to an embodiment.

As illustrated in FIGS. 5A and 5B, a light receiving element 41 is connected to a controller 81 and the controller 81 controls operations of the light receiving element 41. If the light receiving element 41 includes a camera module (not shown) to capture images of a detective region, the controller 81 may control image capturing of the camera module.

As illustrated in FIG. 5A, the controller 81 includes a first control channel 81a and a second control channel 81b, each respectively connected to the first light receiving element 41a and the second light receiving element 41b. In this case, the controller 81 may control the first light receiving element 41a and the second light receiving element 41b independently of each other via the first control channel 81a and the second control channel 81b.

As illustrated in FIG. 5B, an exemplary controller 82 includes only one control channel 82a. To control the plurality of light receiving elements 41a and 41b using the single control channel 82a, connectors 90 are connected to the controller 82 and the light receiving elements 41a and 41b. The connectors 90 connect the control channel 82a of the controller 82 to any one or more of the plurality of light receiving elements 41a and 41b.

The connectors 90 may include a first connector 90a connected to the first light receiving element 41a and the control channel 82a of the controller 82 and a second connector 90b connected to the second light receiving element 41b and the control channel 82a of the controller 82. The first connector 90a and the second connector 90b may be level translators that may be turned on or off.

If the first connector 90a is turned on and the second connector 90b is turned off, the controller 82 controls the first light receiving element 41a. Likewise, the controller 82 may control the second light receiving element 41b by turning off the first connector 90a and turning on the second connector 90b. On/Off of the first connector 90a and the second connector 90b may be controlled by a separate controller or may be directly controlled by an operator.

As is apparent from the above description, as a result of providing a sample analysis apparatus with a plurality of light receiving elements, detecting reaction results of detection objects located at different radial distances of a disc may be accomplished. Further, the sample analysis apparatus has the ability to irradiate a uniform intensity of light onto the plurality of detection objects, which enables more accurate measurement of reaction results.

Finally, the sample analysis apparatus may control a plurality of light emitting and receiving elements using only a single controller, thus reducing manufacturing costs.

Although a few exemplary embodiments have been shown and described, it would be appreciated by those skilled in the art that changes may be made in these embodiments without departing from the principles and spirit of the inventive concept, the scope of which is defined in the claims and their equivalents.

What is claimed is:

1. A sample analysis apparatus comprising:
a disc including a first detective region and a second detective region, wherein the first detective region is located at a first distance in a radial direction from a center of the disc, the second detective region is located at a second distance in the radial direction from the center of the disc, and the second distance greater than the first distance;
a light emitting element positioned a predetermined distance from a first side of the disc so as to face the first detective region and the second detective region, wherein the light emitting element is configured to irradiate a uniform intensity of light onto at least one of the first detective region and the second detective region; and
a first light receiving element and a second light receiving element arranged a second side of the disc that is opposite the first side of the disc and oriented respectively to face the first detective region and the second detective region.

2. The apparatus according to claim 1, wherein a light emitting surface of the light emitting element irradiates both the first detective region and the second detective region.

3. The apparatus according to claim 1, wherein the light emitting element includes a backlight unit configured to irradiate a uniform intensity of light in a given direction.

4. The apparatus according to claim 1, wherein the first light receiving element detects an amount of light transmitted through the first detective region.

5. The apparatus according to claim 1, wherein the first light receiving element includes a camera module configured to capture images of the first detective region.

6. The apparatus according to claim 1,
wherein the light emitting element is disposed above the disc, and
wherein the first light receiving element is disposed below the disc.

7. The apparatus according to claim 1, further comprising a controller configured to control operations of the first light receiving element and the second light receiving element,
wherein the controller includes a plurality of control channels and is connected to the first light receiving element and the second light receiving element via the respective control channels.

8. The apparatus according to claim 1, further comprising:
a controller configured to control operations of any one of the first light receiving element and the second light receiving element; and
a connector that connects the first light receiving element and the second light receiving element to the controller.

9. The apparatus according to claim 8, wherein the connector includes a first connector that connects the controller and the first light receiving element to each other and a second connector that connects the controller and the second light receiving element to each other.

10. A sample analysis apparatus comprising:
a rotating device, to which at least one of a first disc and a second disc is selectively mounted, wherein the first disc has a first radius and includes a first detective region and the second disc has a greater radius than the first radius and includes a second detective region;
a light emitting element that is spaced apart from the first disc and the second disc and is configured to irradiate a uniform intensity of light onto the first detective region and the second detective region; and
a first light receiving element and a second light receiving element that are spaced apart from the first detective region and the second detective region and are configured to receive light transmitted through the first detective region and the second detective region, respectively.

11. The apparatus according to claim 10,
wherein the light emitting element has a light emitting surface to irradiate a uniform intensity of light in a given direction, and
wherein the first detective region and the second detective region are contained in a light emitting region of the light emitting surface.

12. The apparatus according to claim 10, wherein each of the first light receiving element and the second light receiving element includes a camera module configured to detect the amount of light transmitted through the first detective region.

13. The apparatus according to claim 10, further comprising:
a controller configured to control operations of the first light receiving element and the second light receiving element; and
a connector that connects the first light receiving element and the second light receiving element to the controller,
wherein the connector includes a first connector that connects the controller and the first light receiving element to each other and a second connector that connects the controller and the second light receiving element to each other.

14. A sample analysis apparatus comprising:
a disc including a first detective region and a second detective region spaced radially apart from each other;
a light emitting element that is disposed on a first side of the disc and is configured to irradiate a uniform intensity of light onto the first detective region and the second detective region;
a first light receiving element and a second light receiving element that are disposed on a second side of the disc that is opposite the first side of the disc and are configured to receive light transmitted through the first detective region and the second detective region, respectively;
a controller configured to control operations of the first light receiving element and the second light receiving element; and
a connector configured to selectively connect only one of the first light receiving element and the second light receiving element to the controller.
